(19) United States
(12) Patent Application Publication
(10) Pub. No.: US 2021/0217034 A1
(43) Pub. Date: Jul. 15, 2021

(54) RENT CALCULATION APPARATUS, RENT CALCULATION METHOD, AND PROGRAM

(71) Applicant: NEC CORPORATION, Tokyo (JP)

(72) Inventors: Shigetsu SAITO, Tokyo (JP); Jun KOBAYASHI, Tokyo (JP)

(73) Assignee: NEC CORPORATION, Tokyo (JP)

(21) Appl. No.: 15/999,782

(22) PCT Filed: Mar. 16, 2017
(86) PCT No.: PCT/JP2017/010729

§ 371 Date: Aug. 20, 2018

(30) Foreign Application Priority Data
Mar. 23, 2016 (JP) 2016-057996

(51) Int. Cl. G06Q 30/02; G06Q 30/06; G06K 9/00

(52) U.S. Cl. CPC G06Q 30/0206; G06K 9/00704; G06Q 30/0645

(57) ABSTRACT

An acquisition unit configured to acquire information about passing states of streets in a predetermined area in which there are a plurality of stores, and a rent calculation unit configured to calculate rents of the stores on the basis of passing states of the streets and relative positions between the streets and the stores are included.

### TECHNICAL FIELD

The present invention relates to a rent calculation apparatus, a rent calculation method, and a program.

### BACKGROUND ART

A rent of a store in a predetermined area such as a shopping mall may be determined depending on the position in the predetermined area.

Patent Document 1 discloses, as a related technology, a system which calculates a difference between a rate of increase/decrease of the number of customers of an entire facility and a rate of increase/decrease of the number of customers for each tenant and changes (discounts or surcharges) a predetermined store rent on the basis of the difference.

### CITATION LIST

### Patent Literature

[Patent Document 1]

Japanese Unexamined Patent Application, First Publication No. 2014-021885

### SUMMARY OF INVENTION

### Technical Problem

However, when a rent of a store is set, a borrower of the store may not be satisfied with the rent. Even when the technology disclosed in Patent Document 1 is used, a rent of a store is corrected according to the number of store visits and is not based on location conditions including potential customers of the store and the like. Accordingly, rent setting with which a store borrower is not satisfied may be performed.

An object of the present invention is to provide a rent calculation apparatus, a rent calculation method, and a program capable of solving the aforementioned problem.

### Solution to Problem

A rent calculation apparatus according to a first aspect of the present invention includes an acquisition unit configured to acquire information about passing states of streets in a predetermined area in which there arc a plurality of stores and a rent calculation unit configured to calculate rents of the stores on the basis of passing states of the streets and relative positions between the streets and the stores.

A rent calculation method according to a second aspect of the present invention includes acquiring information about passing states of streets in a predetermined area in which there are a plurality of stores and calculating rents of the stores on the basis of passing states of the streets and relative positions between the streets and the stores.

A program according to a third aspect of the present invention causes a computer of a rent calculation apparatus to execute processes of acquiring information about passing states of streets in a predetermined area in which there are a plurality of stores and calculating rents of the stores on the basis of passing states of the streets and relative positions between the streets and the stores.

### Advantageous Effects of Invention

According to the present invention, it is possible to perform rent setting with which a borrower of a store is satisfied by setting a rent of the store on the basis of passing states of passages and relative positions between the passages and the store.

### BREIEF DESCRIPTION OF DRAWINGS

FIG. 1 is a diagram showing a minimum configuration of a rent calculation apparatus according to a first embodiment of the present invention.

FIG. 2 is a diagram showing a configuration of a rent calculation system according to a second embodiment of the present invention.

FIG. 3 is a diagram showing a configuration of a rent calculation apparatus according to the second embodiment of the present invention.

FIG. 4 is a diagram showing a data table in the second embodiment of the present invention.

FIG. 5 is a diagram showing a configuration of a passing state acquisition system according to the second embodiment of the present invention.

FIG. 6 is a diagram showing a processing flow of the rent calculation system according to the second embodiment of the present invention.

FIG. 7 is a diagram showing a configuration of the passing state acquisition system according to the second embodiment of the present invention.

FIG. 8 is a diagram showing a processing flow of a rent calculation system according to a third embodiment of the present invention.

### DESCRIPTION OF EMBODIMENTS

### First Embodiment

Hereinafter, embodiments will be described in detail with reference to the drawings.

A rent calculation apparatus according to a first embodiment of the present invention will be described.

The rent calculation apparatus according to the first embodiment of the present invention is a rent calculation apparatus having a minimum configuration of the present invention.

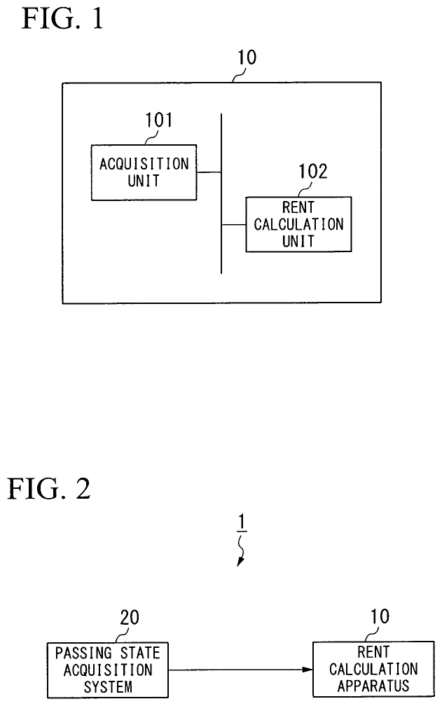

As shown in FIG. 1, the rent calculation apparatus 10 according to the first embodiment of the present invention includes at least an acquisition unit 101 and a rent calculation unit 102.

The passing state acquisition unit 101 acquires information about passing states of streets (also called passages) in a predetermined area in which there are a plurality of stores.

The rent calculation unit 102 calculates a rent of a corresponding store on the basis of passing states of streets and relative positions between the streets and the store in the predetermined area in which there are a plurality of stores.

In this manner, the rent calculation apparatus 10 may perform rent setting with which a borrower of the store is satisfied by setting a rent of the store on the basis of passing states of passages and relative positions between the passages and the store.

### Second Embodiment

A rent calculation system according to a second embodiment of the present invention will be described.

As shown in FIG. 2, the rent calculation system 1 according to the second embodiment of the present invention includes a rent calculation apparatus 10 and a passing state acquisition system 20.

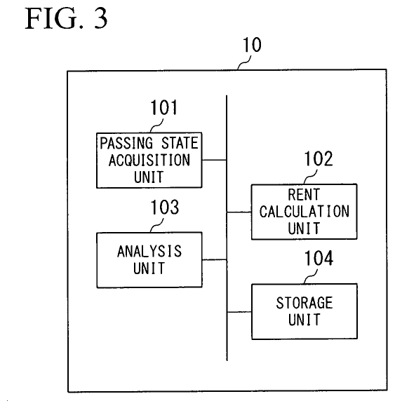

As shown in FIG. 3, the rent calculation apparatus 10 includes a passing state acquisition unit 101 (acquisition unit), a rent calculation unit 102, an analysis unit 103 and a storage unit 104.

The passing state acquisition unit 101 acquires results of measurement of passing states (information about passing states) of streets in a predetermined area (region) in which there are a plurality of stores.

Specifically, the passing state acquisition unit 101 acquires a passing state analysis result analyzed by the analysis unit 103 which will be described later.

The rent calculation unit 102 calculates a rent of a store on the basis of passing states of streets and relative positions between the streets and the store in the predetermined area in which there are a plurality of stores.

Specifically, the rent calculation unit 102 calculates a rent of a store according to passing states (pedestrian volume, stay times of pedestrians (stay state), moving speeds (passing speeds) of pedestrians, attributes of pedestrians, and the like) of streets identified by the analysis unit 103 and relative positions between the streets and the store.

The analysis unit 103 analyzes results of measurement of passing states of streets in a predetermined area in which there are a plurality of stores, which are obtained from the passing state acquisition system 20 which will be described later.

For example, the analysis unit 103 detects pedestrian volume, stay time of pedestrians, moving speeds of pedestrians, attributes of pedestrians and the like on the basis of the results of measurement of passing states of streets.

The storage unit 104 stores various types of information necessary for processes performed by the rent calculation apparatus 10.

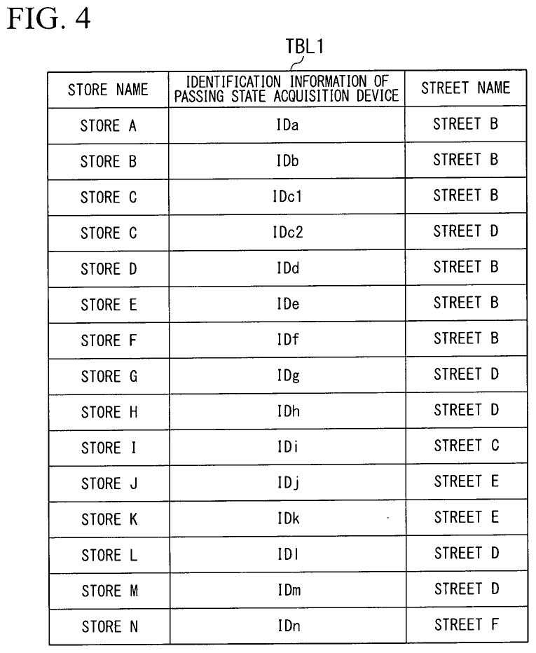

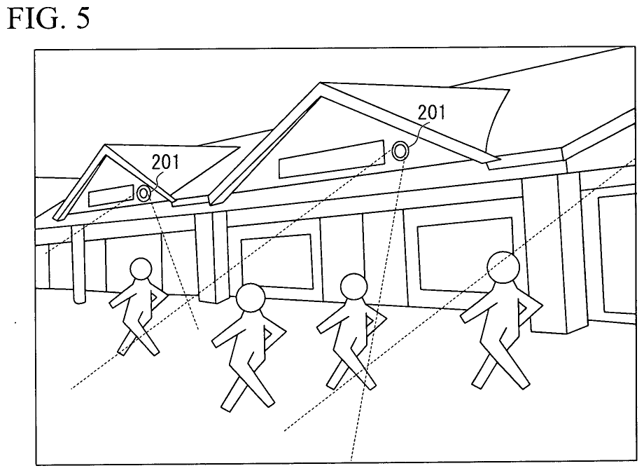

For example, the storage unit 104 stores a data table TBL1 shown in FIG. 4. The data table TBL1 shows correlations between names of stores, identification information of passing state acquisition devices 201 installed in the stores, and names of streets from which the passing state acquisition device 201 acquires passing states.

The passing state acquisition system 20 includes one or more passing state acquisition devices 201, as shown in FIG. 5.

The passing state acquisition device 201 acquires passing states of streets in a predetermined area in which there are a plurality of stores.

For example, the passing state acquisition device 201 is an image pickup apparatus such as a camera, a communication apparatus which is able to communicate with mobile terminals such as smartphones carried by pedestrians, a distance sensor such as an infrared, laser or ultrasonic sensor, or the like.

For example, as shown in FIG. 5, the passing state acquisition device 201 is provided at a position of the surface of a wall of a store which faces streets at which the passing state acquisition device 201 may overlook pedestrians of the street.

Next, processes of the rent calculation system I according to the second embodiment of the present invention will be described.

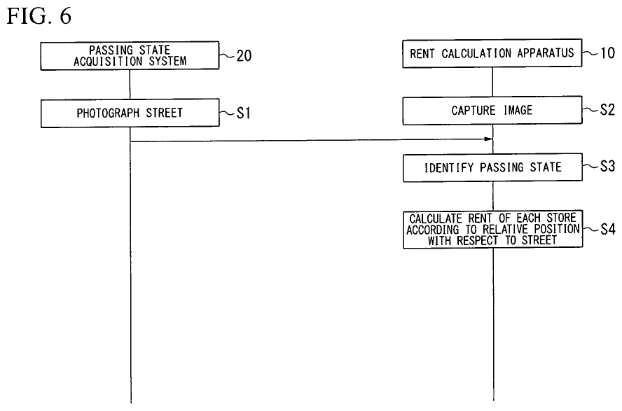

Here, a processing flow of the rent calculation system 1 according to the second embodiment of the present invention shown in FIG. 6 will be described.

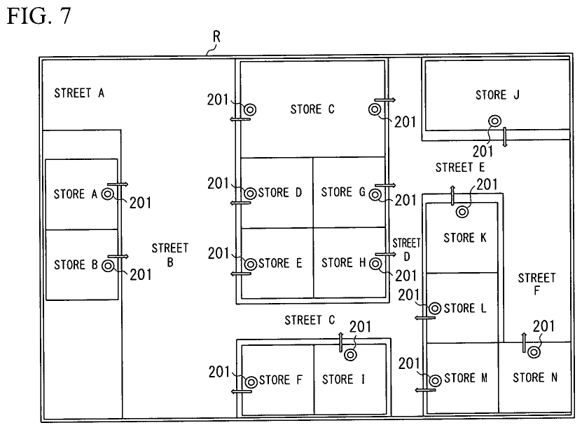

Meanwhile, it is assumed that the rent calculation system 1 has the configuration shown in FIG. 2. It is assumed that the rent calculation apparatus 10 has the configuration shown in FIG. 3. The passing state acquisition system 20 includes one or more passing state acquisition devices 201 as shown in FIG. 5. In addition, in the passing state acquisition system 20, the passing state acquisition device 201 is provided at a position in each store of a shopping mall at which the passing state acquisition device 210 is able to acquire passing states of pedestrians of streets in a direction of an arrow, as shown in FIG. 7. An area indicated by a symbol R in FIG. 7 is an example of a predetermined area in which there are a plurality of stores.

The passing state acquisition device 201 provided in a store E photographs a street (step S1).

The analysis unit 103 acquires an image of a street captured by each passing state acquisition device 201 from each passing state acquisition device 201 with reference to the data table TBL1 (FIG. 4) (step S2).

For example, the analysis unit 103 acquires an image of a street B from the passing state acquisition device 201 (IDc1) of a store C and acquires an image of a street D from the passing state acquisition device 201 (1Dc2) of the store C. Further, the analysis unit 103 acquires an image of the street B from the passing state acquisition device 201 of the store E, for example. In addition, the analysis unit 103 acquires an image of a street F from the passing state acquisition device 201 of a store N, for example.

The analysis unit 103 identifies passing states included in images acquired from the passing state acquisition system 20 (step S3).

Specifically, the analysis unit 103 analyzes the images acquired from the passing state acquisition system 20 to identify pedestrians (persons).

In addition, the analysis unit 103 calculates pedestrian volume per unit time by counting a total number of identified pedestrians and dividing the total number by a total time, for example.

Further, the analysis unit 103 calculates movement distances of the identified pedestrians on the basis of the number of pixels of the images and angles of view of the passing state acquisition devices 201, for example. The analysis unit 103 calculates at least one of stay times of the pedestrians and walking speeds of the pedestrians using the calculated movement distances and time taken for movement.

In addition, the analysis unit 103 estimates attributes such as sexes and ages of the identified pedestrians on the basis of images of the faces and skin of the pedestrians, for example.

The analysis unit 103 transmits the identified passing states of streets to the passing stale acquisition unit 101.

The passing state acquisition unit 101 receives the passing states of streets from the analysis unit 103. Accordingly, the passing state acquisition unit 101 acquires results of measurement of passing states of streets in the predetermined area in which there are a plurality of stores through the analysis unit 103.

The passing state acquisition unit 101 transmits the passing states of the streets received from the analysis unit 103 to the rent calculation unit 102.

The rent calculation unit 102 calculates a rent of each store on the basis of the received passing states of the streets and relative positions between the streets and stores (step S4).

For example, in calculation of a rent of the store E, the rent calculation unit 102 calculates a rent of the store E on the basis of a passing state of the street B received from the passing state acquisition unit 101, the passing state of the street B being identified by the analysis unit 103 on the basis of an image (video) captured by the passing state acquisition device 201 of the store E.

Specifically, when the analysis unit 103 has identified pedestrian volume, the rent calculation unit 102 calculates the rent of the store Eon the basis of correlations between the pedestrian volume and rent ranks. There is a high likelihood that a place where there is a large pedestrian volume is a place that attracts pedestrians. Accordingly, the correlations between the pedestrian volume and the rent ranks show that the rent increases as the pedestrian volume increases.

Specifically, when the analysis unit 103 has identified stay times of pedestrians, the rent calculation unit 102 calculates the rent of the store E on the basis of correlations between the stay times of pedestrians and the rent ranks. There is a high likelihood that a place having long stay times of pedestrians is a place that attracts pedestrians. Accordingly, the correlations between the stay times of pedestrians and the rent ranks show that the rent increases as the stay times of pedestrians increase.

In addition, specifically, when the analysis unit 103 has identified walking speeds of pedestrians, the rent calculation unit 102 calculates the rent of the store Eon the basis of correlations between the walking speeds of pedestrians and the rent ranks. There is a high likelihood that a place where walking speeds of pedestrians are slow is a place that attracts pedestrians. Accordingly, the correlations between the walking speeds of pedestrians and the rent ranks show that the rent increases as the walking speeds of pedestrians decrease.

Further, specifically, when the analysis unit 103 has identified attributes such as sexes and ages of pedestrians, the rent calculation unit 102 calculates the rent of the store E on the basis of a degree of matching between attributes of pedestrians that a borrower of the store E desires and the attributes of pedestrians identified by the analysis unit 103. When the attributes of pedestrians identified by the analysis unit 103 match the attributes of pedestrians that the borrower of the store E desires, a likelihood of pedestrians using the store E increases. Accordingly, the rent increases as the degree of matching between attributes of pedestrians that the borrower of the store E desires and the attributes of pedestrians identified by the analysis unit 103 increases.

Meanwhile, when the rent calculation unit 102 calculates the rent of the store E, the rent calculation unit 102 may calculate the rent of the store E on the basis of a passing state of the street B and passing states of streets identified by the analysis unit 103 on the basis of images captured by other passing state acquisition devices 201, from the passing state acquisition unit 101, the a passing state of the street B being identified by the analysis unit 103 on the basis of an image captured by the passing state acquisition device 201 of the store E received.

For example, the rent calculation unit 102 weights each of the passing states of the streets received from the analysis unit 103 according to a distance from the store E. The rent calculation unit 102 may calculate the rent of the store E on the basis of the sum of weighted passing states of the streets.

The processing flow of the rent calculation system 1 according to the second embodiment of the present invention has been described. The above-described rent calculation system 1 according to the second embodiment of the present invention includes the rent calculation apparatus 10 and the passing state acquisition system 20. The passing state acquisition unit 101 acquires results of measurement of passing states of streets in a predetermined area in which there are a plurality of stores. The rent calculation unit 102 calculates a rent of a store on the basis of passing states of streets in the predetermined area in which there are a plurality of stores and relative positions between the streets and the store. The analysis unit 103 analyzes the results of measurement of the passing states of the streets in the predetermined area in which there are a plurality of stores, acquired from the passing state acquisition system 20. The storage unit 104 stores various types of information necessary for processes performed by the rent calculation apparatus 10. The passing state acquisition system 20 includes one or more passing state acquisition devices 201. The passing state acquisition device 201 acquires passing states of streets in the predetermined area in which there are a plurality of stores.

In this manner, the rent calculation apparatus 10 of the rent calculation system 1 is able to perform rent setting with which a store borrower is satisfied by setting a rent of a store on the basis of passing states of passages and relative positions between the passages and the store.

### Third Embodiment

A configuration of a rent calculation system according to a third embodiment of the present invention will be described.

The rent calculation system 1 according to the third embodiment of the present invention includes the rent calculation apparatus 10 and the passing state acquisition system 20 like the rent calculation system 1 of the second embodiment of the present invention shown in FIG. 2.

The passing state acquisition unit 101 acquires results of measurement of passing state for each region set in streets in a predetermined area in which there are a plurality of stores.

Specifically, the passing state acquisition unit 101 acquires results of analysis of passing states for each region analyzed by the analysis unit 103 which will be described later.

The analysis unit 103 analyzes results of measurement of passing states of streets in the predetermined area in which there are a plurality of stores, acquired from the passing state acquisition system 20, for each region set in the streets.

For example, the analysis unit 103 identifies pedestrian volume, stay times of pedestrians, moving speeds of pedestrians, attributes of pedestrians and the like on the basis of the results of measurement of passing states of streets for each region set in the streets.

Next, processes of the rent calculation system 1 according to the third embodiment of the present invention will be described.

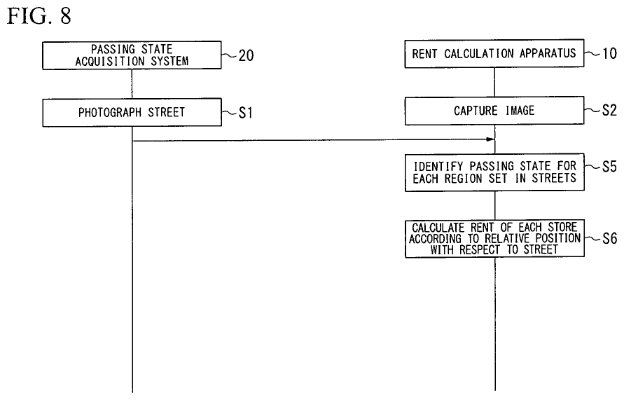

Here, a processing flow of the rent calculation system 1 according to the third embodiment of the present invention shown in FIG. 8 will be described.

The rent calculation system I performs processes of steps S1 and S2 as in the second embodiment.

The analysis unit 103 identifies passing states included in images acquired from the passing state acquisition system 20 for each region set in streets (step S5).

Specifically, the analysis unit 103 analyzes images acquired from the passing state acquisition system 20 to identify pedestrians. The analysis unit 103 classifies the identified pedestrians for each region set in streets.

In addition, the analysis unit 103 calculates pedestrian volume per unit time by counting a total number of pedestrians and dividing the total number by a total time for each classified region, for example.

Further, the analysis unit 103 calculates movement distances of pedestrians on the basis of the number of pixels of the images and face angles of the passing state acquisition devices 201 for each classified region, for example. The analysis unit 103 calculates at least one of stay times of pedestrians and walking speeds of pedestrians using the calculated movement distances of pedestrians and time taken for movement.

In addition, the analysis unit 103 estimates attributes such as sexes and ages of pedestrians on the basis of images of the faces and skins of the pedestrians for each classified region.

The analysis unit 103 transmits passing states of streets for each classified region to the passing state acquisition unit 101.

The rent calculation unit 102 calculates a rent of each store on the basis of the received passing states of streets for each classified region and a relative position between the region and the store (step S6).

For example, when the rent calculation unit 102 calculates the rent of the store E, the rent calculation unit 102 weights passing states of regions received from the passing state acquisition unit 101 according to distances from the store E for each region. The rent calculation unit 102 may calculate the rent of the store E on the basis of the sum of the weighted passing states of regions. The rent calculation unit 102 increases a weight of a region as a distance between the region and the store E becomes close. That is, the rent calculation unit 102 calculates the rent of the store Eon the basis of a passing state of a region near the store E among regions of passages. Alternatively, the rent calculation unit 102 may calculate the rent of the store E on the basis of a passing state of a region neighboring the store E among regions of passages.

The processing flow of the rent calculation system 1 according to the third embodiment of the present invention has been described. The rent calculation system 1 according to the third embodiment of the present invention includes the rent calculation apparatus 10 and the passing state acquisition system 20. The passing state acquisition unit 101 acquires results of measurement of passing states for each region set in passages in a predetermined area in which there are a plurality of stores.

The analysis unit 103 analyzes results of measurement of passing states of passages in the predetermined area in which there are a plurality of stores, acquired from the passing state acquisition system 20, for each region set in the passages. The rent calculation unit 102 calculates a rent of each store on the basis of passing states of passages for each region and a relative position between the region and the store.

In this manner, the rent calculation apparatus 10 of the rent calculation system 1 is able to perform rent setting with which a store borrower is satisfied by setting a rent of a store on the basis of passing states of streets and relative positions between the streets and the store.

Meanwhile, the rent calculation unit 102 may correct a rent of a store according to shapes of passages in embodiments of the present invention.

For example, the rent calculation unit 102 may correct a rent of a store such that the rent of the store increases as the location of the store is closer to a wide passage. Further, the rent calculation unit 102 may correct a rent of a store such that the rent of the store decreases when the store is located at an intricate position at which a passage is bent such as the store N shown in FIG. 7.

Further, the rent calculation unit 102 may correct a rent set for a store on the basis of passing states in the embodiments of the present invention.

For example, when a place less attracts pedestrians (e.g., when the absolute quantity of pedestrian volume has decreased) compared to a previous time when a rent of a store in the place was set, the rent calculation unit 102 may correct the rent such that the rent of the store decreases next time. In addition, when a place further attracts pedestrians (e.g., when the absolute quantity of pedestrian volume has increased) compared to a previous time when a rent of a store in the place was set, the rent calculation unit 102 may correct the rent such that the rent of the store increases next time.

Further, with respect to the processing flows in the embodiments of the present invention, the order of processes may be changed within a range in which appropriate processes are performed.

Each of storage units other than the storage unit 104 in the embodiments of the present invention may be included in any place within a range in which appropriate information transmission and reception are performed. In addition, a plurality of storage units other than the storage unit 104 may be provided within a range in which appropriate information transmission and reception are performed and may store data in a distributed manner.

Although embodiments of the present invention have been described, each of the aforementioned rent calculation apparatus 10 and the passing state acquisition system 20 may include a computer system therein. In addition, procedures of the aforementioned processes are stored in the form of a program in a computer readable recording medium, and the processes are performed by a computer reading and executing the program. Here, the computer readable recording medium refers to a magnetic disc, a magneto-optic disk, a CD-ROM, a DVD-ROM, a semiconductor memory and the like. In addition, such a computer program may be delivered to a computer through a communication line and the computer which has received the distribution may execute the program.

Furthermore, the aforementioned program may realize part of the above-described functions. Further, the program may be a file, so-called a difference file (difference program) which can be realized by combining the above-described functions with a program recorded in a computer system in advance.

Although several embodiments of the present invention have been described, such embodiments are examples and do not limit the scope of the invention. With respect to such embodiments, addition, various kinds of omission, substitution and change may be performed without departing from the essential characteristics of the invention.

Priority is claimed on Japanese Patent Application No. 2016-057996, filed Mar. 23, 2016, the content of which is incorporated herein by reference.

### INDUSTRIAL APPLICABILITY

According to the present invention, it is possible to perform rent setting with which a store borrower is satisfied by setting a rent of a store on the basis of passing states of passages and relative positions between passages and stores.

### REFERENCE SIGNS LIST

1 Rent calculation system

10 Rent calculation apparatus

20 Passing state acquisition system

101 Passing state acquisition unit, acquisition unit

102 Rent calculation unit

103 Analysis unit

104 Storage unit

201 Passing state acquisition device

1. A rent calculation apparatus comprising:
an acquisition unit configured to acquire information about passing states of streets in a predetermined area in which there are a plurality of stores; and
a rent calculation unit configured to calculate rents of the stores on the basis of passing states of the streets and relative positions between the streets and the stores.

2. The rent calculation apparatus according to claim 1, wherein the streets include a plurality of regions, and
wherein the acquisition unit is configured to acquire information about passing states for each of the regions, and the rent calculation unit is configured to calculate rents of the stores on the basis of passing states of the regions and relative positions between the regions and the stores.

3. The rent calculation apparatus according to claim 2, wherein the rent calculation unit is configured to calculate rents of the stores on the basis of passing states in regions near the stores and relative positions between the regions and the stores.

4. The rent calculation apparatus according to claim 3, wherein the rent calculation unit is configured to calculate rents of the stores on the basis of passing states in regions neighboring the stores and relative positions between the regions and the stores.

5. The rent calculation apparatus according to claim 1, wherein the passing states include at least one of stay states and passing speeds of persons located on the streets.

6. The rent calculation apparatus according to claim 1, wherein the rent calculation unit is configured to correct rents of the stores according to shapes of the streets.

7. The rent calculation apparatus according to claim 1, wherein the rent calculation unit is configured to correct rents set for the stores on the basis of the passing states.

8. A rent calculation method comprising:
acquiring information about passing states of streets in a predetermined area in which there are a plurality of stores; and
calculating rents of the stores on the basis of passing states of the streets and relative positions between the streets and the stores.

9. A program causing a computer of a rent calculation apparatus to execute processes of:
acquiring information about passing states of streets in a predetermined area in which there are a plurality of stores; and
calculating rents of the stores on the basis of passing states of the streets and relative positions between the streets and the stores.
